(19) United States
(12) Patent Application Publication
(10) Pub. No.: US 2024/0129215 A1
(43) Pub. Date: Apr. 18, 2024

(54) DELAY MEASUREMENT DEVICE, DELAY MEASUREMENT METHOD, AND PROGRAM

(71) Applicant: Nippon Telegraph and Telephone Corporation, Tokyo (JP)

(72) Inventors: Kazuma KAMIENOO, Musashino-shi, Tokyo (JP); Ken TAKAHASHI, Musashino-shi, Tokyo (JP); Hiroki MORI, Musashino-shi, Tokyo (JP); Rena OMACHI, Musashino-shi, Tokyo (JP)

(21) Appl. No.: 18/277,829

(22) PCT Filed: Feb. 18, 2021
(86) PCT No.: PCT/JP2021/006173

§ 371 Date: Aug. 18, 2023

(51) Int. Cl. H04L 43/087

(52) U.S. Cl. CPC H04L 43/087; H04L 41/12

(57) ABSTRACT

A delay measurement device includes a NW measurement unit that measures a topology, a delay amount of each link, jitter, and a packet loss rate, and causes a NW state holding unit to hold them as NW state information, a link quality calculation unit that calculates the link quality between the end points as a weight on the basis of the NW state information including the topology, the delay amount of each link, the jitter, and the packet loss rate, and a path calculation function unit that calculates a measurement path on the basis of a weighted topology in which the weight of the link quality calculated by the link quality calculation unit is reflected in the topology. The NW measurement unit transmits a measurement packet to a start point and measures the delay amount of a measurement target section of a NW.

### TECHNICAL FIELD

The present invention relates to a delay measurement device, a delay measurement method, and a program for setting an appropriate network configuration according to a use situation of a network.

### BACKGROUND ART

Due to the penetration of 5G and e-sports, strict network (hereinafter, appropriately referred to as NW) requirements such as ultra-low delay and low jitter have been demanded. In order to provide a network satisfying the requirements, it is necessary to have a technique of accurately grasping quality such as a delay amount, jitter (deviation of the delay amount), and a packet loss rate.

As a method of measuring the delay amount and the jitter in the NW, there are a method in which measurement devices are disposed at both ends of a measurement target section and a measurement packet such as an Internet Control Message Protocol (ICMP) packet is transmitted and received between the measurement devices, and a method using a Two-Way Active Measurement Protocol (TWAMP) in which a measurement packet is exchanged between routers in a network (see Non Patent Literature 1).

Non Patent Literature 1 proposes a method of measuring a delay amount and jitter in an arbitrary section of the entire network by connecting a measurement system to one place of the network by using segment routing (SR), which is a routing method capable of explicitly designating a path of the network.

FIG. 15 is a block diagram illustrating a configuration of a delay measurement system based on a delay amount and jitter measurement method using an SR mechanism.

As illustrated in FIG. 15, the delay measurement system is connected to a delay measurement target network 10, and the measurement target network 10 includes end points (A-F) (see A-F enclosed by blocks in FIG. 15; hereinafter, the same description will be given in each drawing), which are input and output points, and links (see the solid lines connecting devices A-F in FIG. 15; hereinafter, the same description will be given in each drawing) between the end points (A-F). Note that the end points (A-F) may be referred to as routers (A-F) or devices (A-F).

In FIG. 15, a case where the delay measurement system measures the delay amount and the jitter from a start point end point (hereinafter, referred to as a start point) D to an end point end point (hereinafter, referred to as an end point) E is taken as an example. However, since the delay measurement system is connected to the end point B, in a case where the delay amount and the jitter at the end points D-E are measured, the delay measurement system is affected by the delay or the like at the end points B-D.

In the measurement method of FIG. 15, measurement <1> (see the thick solid line arrow a in FIG. 15) in which a packet is transmitted and returned through a path from the delay measurement system to the start point D of the measurement target section and measurement <2> (see the thin solid line arrow b in FIG. 15) in which a packet is transmitted and returned through a path from the delay measurement system to the end point E via the start point D. In each of measurement <1> and measurement <2>, a round trip time (RTT) is measured by transmitting a packet back and forth. The delay amount in the measurement target section is measured by calculating the RTT difference between the pre-section return and the section return.

When the measurement result by measurement <1> is 20 μs and the measurement result by the measurement <2> is 40 μs, the D-E measurement result is calculated by Formula (1) described below.

(Measurement <1>−Measurement <2>)/2 (1)

In the case of FIG. 15, according to Formula (1), B-D delay: 10 μs and D-E delay: 10 μs. Note that B-D delay: 10 μs and D-E delay: 10 μs are the actual quality.

Next, the influence of quality deterioration will be described with reference to FIGS. 16 to 18.

The quality deterioration includes an influence of jitter up to the measurement start point and an influence of packet loss up to the measurement start point.

<Influence of Jitter>

FIG. 16 is a diagram illustrating an influence in a case where the jitter increases in a path (B-D section) from the delay measurement system of FIG. 15 to the measurement start point.

In a case where there is an influence of the jitter up to the measurement start point, the delay amount of the pre-section return (measurement <1>) and the measurement of the section return (measurement <2>) of the measurement target (D-E section) varies due to the influence of the jitter.

For example, it is assumed that the measurement result by measurement <1> is 20 μs and the measurement result by measurement <2> is 220 μs. In this case, according to above Formula (1), D-E delay: 100 μs, which deviates from D-E delay: 10 μs, which is the actual quality. That is, as indicated by the sign b in FIG. 16, since there is the jitter influence to the measurement start point D, here, B-D delay: 10 to 100 μs (jitter large), the measurement result (100 μs) deviates from the actual value (10 μs).

FIG. 17 is an image diagram describing a deviation between a measurement result and an actual delay.

With respect to the actual delay of the thick solid line in FIG. 17, the measurement result of the thin solid line in FIG. 17 varies at B-D delay: 10 to 100 μs, and this delay variation is expressed as large jitter on the measurement time.

As described above, in the delay measurement system of FIG. 15, there is a possibility that the measurement result deviates from an actual value due to the influence of jitter up to the measurement start point.

<Influence of Packet Loss>

FIG. 18 is a diagram illustrating an influence of packet loss in a path (B-D section) from the delay measurement system of FIG. 15 to the measurement start point.

In a case where packet loss due to quality deterioration occurs in the path to the measurement start point, it is conceivable that the measurement fails due to the loss of the measurement packet or a loss rate higher than the actual packet loss rate is recorded.

For example, it is assumed that the measurement result by measurement <1> is 20 μs, and the measurement fails due to packet loss in measurement <2> (see the sign c in FIG. 18).

As indicated by the broken-line arrow indicated by the sign b in FIG. 18, there is a packet loss influence up to the measurement start point D, here, B-D packet loss rate: 30%. Therefore, the measurement fails between D and E, which is the measurement target section, despite packet loss rate: 0%. In addition, in a case where the packet loss is high, the measurement result may deviate from the actual value similarly to the case of FIG. 16.

As described above, in the delay measurement system of FIG. 15, there is a possibility that the measurement result deviates from an actual value or the measurement fails due to the influence of packet loss up to the measurement start point.

### CITATION LIST

### Non Patent Literature

Non Patent Literature 1: Hiroki Mori, and four others, “Proposal of high accuracy delay measurement system”, IEICE Technical Report, NS2019-231(2020-03), pp. 301-306, March 2020.

### SUMMARY OF INVENTION

### Technical Problem

In the method of Non Patent Literature 1, the minimum hop path is adopted as the path to the measurement start point, and the quality such as the delay amount, the jitter, and the packet loss is not taken into account. Therefore, there is a concern that the measurement accuracy deteriorates such that the delay amount, the jitter, and the packet loss in the measurement target section are calculated to be larger than the actual values due to the quality deterioration up to the measurement start point. For example, as described with reference to FIGS. 16 and 17, in a case where the jitter increases in the path from the delay measurement system to the measurement start point, there is a concern that the delay amount and the jitter in the measurement target section are calculated to be larger than actual ones, and accurate information cannot be measured. In addition, as described with reference to FIG. 18, in a case where packet loss due to quality deterioration occurs in the path to the measurement start point, it is conceivable that the measurement fails due to the loss of the measurement packet or a loss rate higher than the actual packet loss rate is recorded.

The present invention has been made in view of such a background, and an object is to provide a delay measurement device, a delay measurement method, and a program that minimize the influence of quality deterioration outside a measurement target.

### Solution to Problem

In order to achieve the above object, the present invention is a delay measurement device that measures a delay of a network (NW) configured by connecting a plurality of end points to each other, the delay measurement device including: a NW measurement unit that measures a topology, a delay amount of each link, jitter, and a packet loss rate, and causes a NW state holding unit to hold them as NW state information; a link quality calculation unit that calculates a link quality between the end points as a weight on the basis of the NW state information including the topology, the delay amount of each link, the jitter, and the packet loss rate; and a path calculation function unit that calculates a measurement path on the basis of a weighted topology in which the weight of the link quality calculated by the link quality calculation unit is reflected in the topology, in which the NW measurement unit transmits a measurement packet to a start point end point and measures a delay amount of a measurement target section of the NW on the basis of the measurement path calculated by the path calculation function unit.

### Advantageous Effects of Invention

According to the present invention, it is possible to provide a delay measurement device, a delay measurement method, and a program that minimize the influence of quality deterioration outside a measurement target.

### BRIEF DESCRIPTION OF DRAWINGS

FIG. 1 is a diagram illustrating a configuration example of a delay measurement device according to an embodiment of the present invention.

FIG. 2A is a flowchart illustrating overall processing of a delay measurement method of the delay measurement device according to the present embodiment.

FIG. 2B is a subroutine of step S2 in FIG. 2A.

FIG. 2C is a subroutine of step S11 in FIG. 2B.

FIG. 3 is a diagram describing an operation of the delay measurement device according to the present embodiment at <time of initial measurement>.

FIG. 4 is a diagram illustrating an example of weighting of a link quality calculation unit in the operation diagram of FIG. 3.

FIG. 5 is a diagram illustrating an example of measurement path calculation by a path calculation function unit in the operation diagram of FIG. 3.

FIG. 6 is a diagram describing an operation of the delay measurement device according to the present embodiment at <time of measurement>.

FIG. 7 is a diagram illustrating an example of a measurement result of each link stored in an NW state holding DB in the operation diagram of FIG. 6.

FIG. 8 is a diagram illustrating an example of weighting of a link quality calculation unit in the operation diagram of FIG. 6.

FIG. 9 is a diagram illustrating an example of measurement path calculation by a path calculation function unit in the operation diagram of FIG. 6.

FIG. 10 is a diagram illustrating an example of weight calculation performed on the basis of a past measurement result of the delay measurement device according to the present embodiment.

FIG. 11 is a diagram illustrating a path derivation example in which a first index and a second index are provided in the delay measurement device according to the present embodiment.

FIG. 12 is a diagram illustrating an example of determining a measurement path on the basis of the path derivation example of FIG. 11.

FIG. 13 is a diagram illustrating a configuration example of a delay measurement device according to a modification of the present embodiment.

FIG. 14 is a hardware configuration diagram illustrating an example of a computer that realizes processing of the delay measurement method according to an embodiment of the present invention.

FIG. 15 is a block diagram illustrating a configuration of a delay measurement system based on a delay amount and jitter measurement method using an SR mechanism.

FIG. 16 is a diagram illustrating an influence in a case where the jitter increases in a path (B-D section) from the delay measurement system of FIG. 15 to the measurement start point.

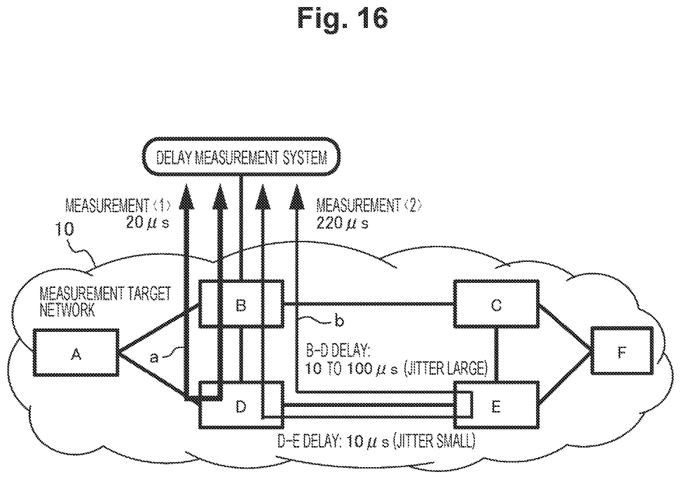

FIG. 17 is an image diagram describing a deviation between a measurement result and an actual delay of FIG. 16.

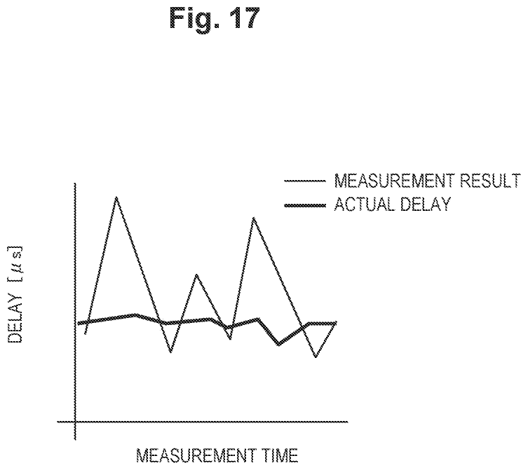

FIG. 18 is a diagram illustrating an influence of packet loss in a path (B-D section) from the delay measurement system of FIG. 15 to the measurement start point.

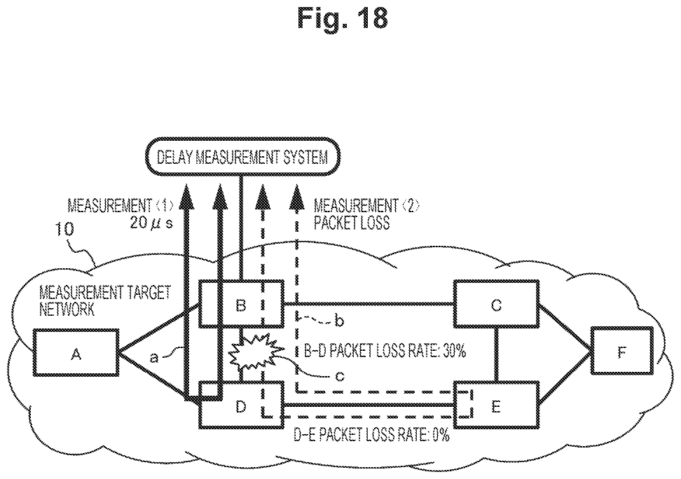

### DESCRIPTION OF EMBODIMENTS

Hereinafter, a delay measurement device and the like according to a mode for carrying out the present invention (hereinafter, referred to as “the present embodiment”) will be described with reference to the drawings. In all the drawings in this specification, components having corresponding functions are denoted by the same reference numerals, and description thereof will be omitted as appropriate.

### Embodiment

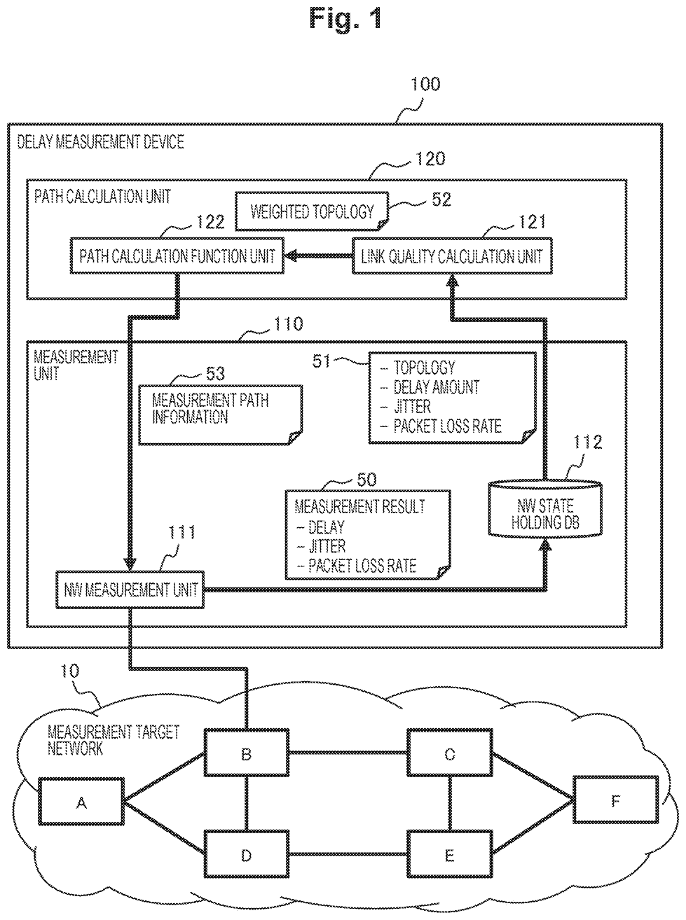

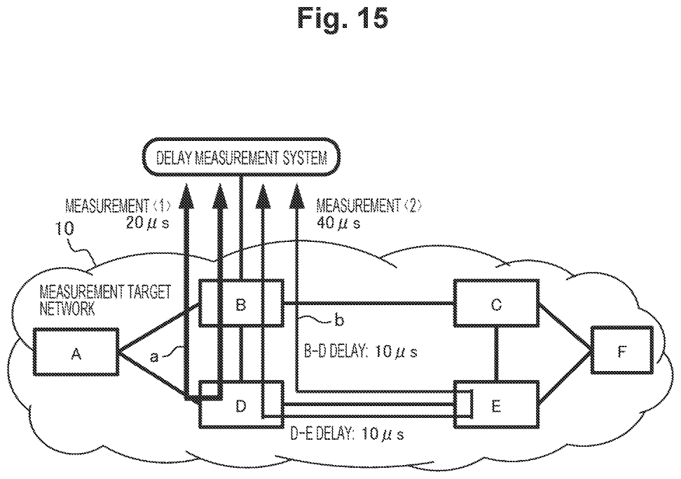

FIG. 1 is a diagram illustrating a configuration example of a delay measurement device 100 according to an embodiment of the present invention. The same components as those in FIG. 15 are denoted by the same reference signs.

As illustrated in FIG. 1, the delay measurement device 100 includes a measurement unit 110 and a path calculation unit 120. The delay measurement device 100 measures a delay of a measurement target network 10 (network) configured by connecting a plurality of end points to each other.

Note that the measurement unit 110 and the path calculation unit 120 constituting the delay measurement device 100 may be realized by independent devices or may be realized by a single device. In addition, the function deployment in each component is an example, and the function deployment between devices may be changed.

<Measurement Target Network>

The measurement target network (communication network) 10 includes nodes and physical links connecting the nodes.

On the measurement target network 10, topology information is advertised by a routing protocol such as information (OSPF/BGP-LS) of a routing protocol operating in the measurement target network 10. The delay measurement device 100 performs transfer on the measurement target network 10 according to a protocol such as MPLS/Segment Routing (SR) or Openflow (registered trademark) in which path control can be performed in units of flows or virtual private networks (VPN).

<Measurement Unit 110>

The measurement unit 110 includes an NW measurement unit 111 and an NW state holding database (DB) 112 (NW state holding unit).

The NW measurement unit 111 measures and collects NW state information (measurement result) including the topology, the delay amount of each link, the jitter, and the packet loss rate, and stores the NW state information in the NW state holding DB 112 (NW state holding unit). The NW state information (measurement result) may include other information such as a traffic volume and a link bandwidth.

In FIG. 1, the NW measurement unit 111 measures the delay amount of each link, the jitter, and the packet loss rate, and stores a measurement result 50 in the NW state holding DB 112.

The NW measurement unit 111 transmits a measurement packet to the start point end point on the basis of the measurement path calculated by a path calculation function unit 122, and measures the delay amount in the measurement target section of the NW.

The topology (NW topology) described above is collected from information (OSPF/BGP-LS) of the routing protocol operating in the measurement target NW. The topology is used to calculate the delay amount of each link.

The delay amount of each link and the jitter are measured using a delay measurement packet or the like.

The traffic volume is acquired by Simple Network Management Protocol (SNMP)/Telemety (registered trademark) that acquires information of traffic counters and device information inside the NW device (hereinafter, simply referred to as the device).

The link bandwidth is collected from config or the like of the device. In addition, information that does not change dynamically, such as the NW topology and the bandwidth, may be manually input.

The NW state holding DB 112 holds the topology, the delay amount of each link, the jitter, and the packet loss rate, and transmits them to a link quality calculation unit 121 of the path calculation unit 120 as past data 51.

<Path Calculation Unit 120>

The path calculation unit 120 includes the link quality calculation unit 121 and the path calculation function unit 122.

The link quality calculation unit 121 calculates the link quality between the end points as a weight on the basis of the topology, the delay amount of each link, the jitter, and/or the packet loss rate.

In addition, the link quality calculation unit 121 calculates the weight of each link using a weight, which is calculated by setting the coefficient in which the avoidance of the packet loss influence is set to the first priority and the avoidance of the jitter influence is set to the second priority, as the first index. The link quality calculation unit 121 calculates the weight of each link using the allowable hop count difference based on the minimum hop path as a second index.

The path calculation function unit 122 calculates a measurement path on the basis of the weighted topology in which the weight of the link quality calculated by the link quality calculation unit 121 is reflected in the topology.

In addition, the path calculation function unit 122 calculates a path in which the weights of the link quality become the minimum sum as a measurement path.

Hereinafter, an operation of the delay measurement device 100 configured as described above and the delay measurement method will be described.

On the measurement target network 10, topology information is advertised by a routing protocol such as OSPF, BGP, or the like, and transfer according to a protocol such as MPLS/Segment Routing (SR) or Openflow (registered trademark) in which path control can be performed in units of flows or virtual private networks (VPN) is enabled.

[Procedure]

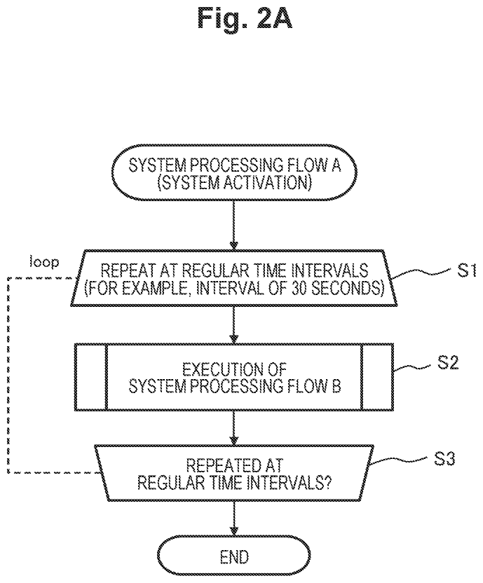

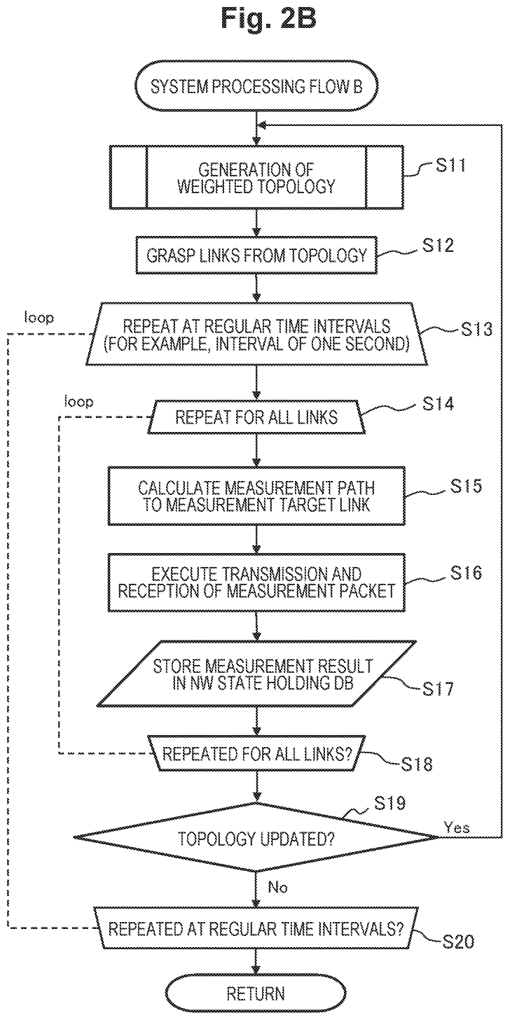

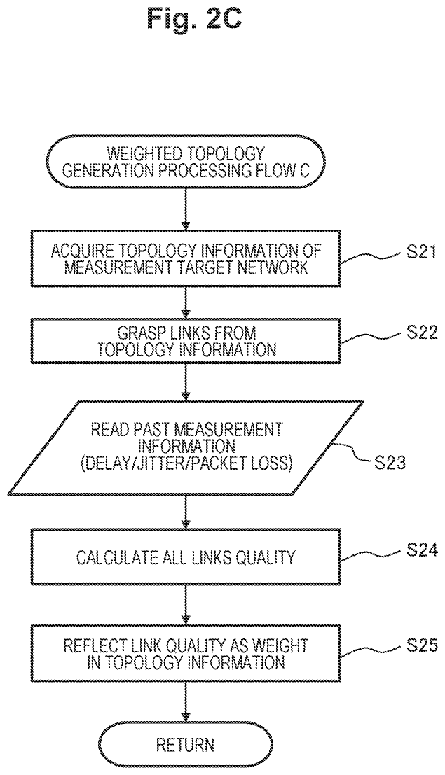

A procedure of the delay measurement method of the delay measurement device 100 will be described with reference to FIGS. 2A to 2C.

<Overall Flow>

FIGS. 2A to 2C are flowcharts illustrating a procedure of the delay measurement method of the delay measurement device 100.

FIG. 2A is a system processing flow A illustrating overall processing of the delay measurement device 100.

When the system is activated, the delay measurement device 100 repeatedly executes a system processing flow B of step S2 (see FIG. 2B) at regular time intervals (for example, an interval of 30 seconds) between the loop start end of step S1 and the loop end of step S3. After repeated execution at regular time intervals, the processing of the present flow ends.

<System Processing Flow B>

FIG. 2B is a flowchart (system processing flow B) illustrating a procedure of the delay measurement method of the delay measurement device 100. The present system processing flow B is a subroutine of step S2 in FIG. 2A.

The processing is started by the subroutine call of step S2 in FIG. 2A, and the path calculation unit 120 generates a weighted topology in step S11. The generation of the weighted topology will be described below with reference to a weighted topology generation processing flow C (see FIG. 2C).

In step S12, the path calculation unit 120 grasps the links from the topology.

In step S13, the path calculation unit 120 repeatedly executes the processing of steps S14 to S19 at regular time intervals (for example, an interval of one second) between the loop start end of step S13 and the loop end of step S20.

In step S14, the path calculation unit 120 repeatedly executes, for all links, the processing of steps S15 to S17 between the loop start end of step S14 and the loop end of step S18.

In step S15, the path calculation function unit 122 of the path calculation unit 120 calculates a measurement path to a measurement target link.

In step S16, the NW measurement unit 111 of the measurement unit 110 executes transmission and reception of the measurement packet.

In step S17, the NW measurement unit 111 holds the measurement result in the NW state holding DB 112.

When the processing of steps S15 to S17 described above is repeated for all links, the processing exits the present loop, and the path calculation unit 120 determines in step S19 whether the topology has been updated. Note that the topology update is updated, for example, every 30 seconds. When the topology update is performed (S19: Yes), the processing returns to step S11.

When the topology update is not performed (S19: No), the processing proceeds to step S20. In step S20, the processing of steps S14 to S19 described above is repeated until it is repeated at regular time intervals.

After repeated execution at regular time intervals, the processing of the present subroutine ends, and the processing proceeds to step S3 in FIG. 2A.

<System Processing Flow C>

FIG. 2C is a flowchart (system processing flow C) illustrating a procedure of the delay measurement method of the delay measurement device 100. The present system processing flow C is a subroutine of step S11 in FIG. 2B.

In step S21, the path calculation unit 120 acquires topology information of the measurement target network 10. The topology information described above is collected from reading of an external file, a router, or the like.

In step S22, the path calculation unit 120 grasps the links from the acquired topology information.

In step S23, the path calculation unit 120 reads past measurement information (delay/jitter/packet loss).

In step S24, the link quality calculation unit 121 of the path calculation unit 120 calculates all links quality.

In step S25, the path calculation function unit 122 of the path calculation unit 120 reflects the link quality as a weight in the topology information, and the processing proceeds to step S12 in FIG. 2B.

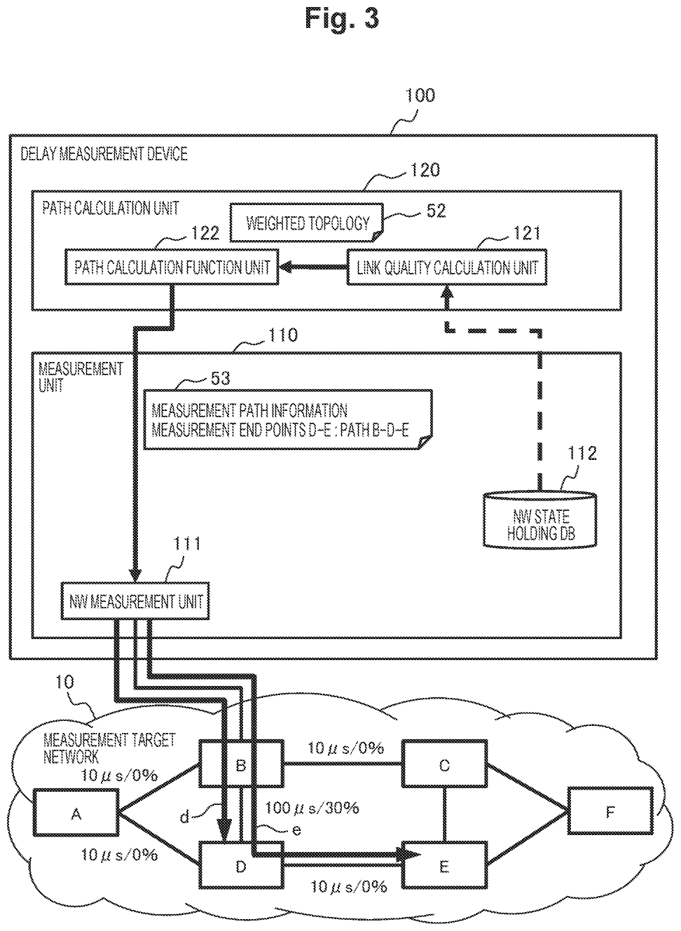

The operation of the delay measurement device 100 will be described with reference to FIGS. 3 to 12.

<Time of Initial Measurement>

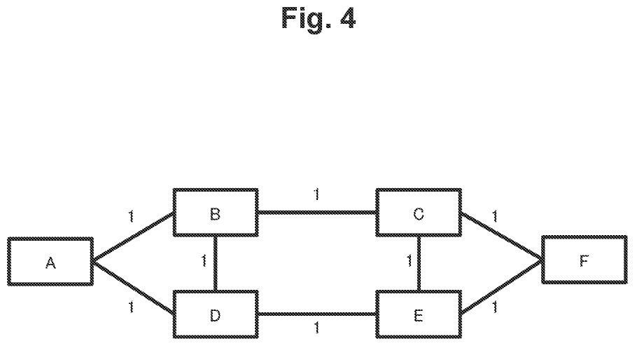

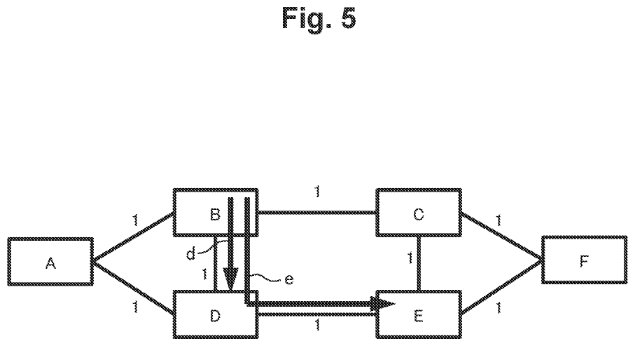

FIG. 3 is a diagram describing an operation of the delay measurement device 100 at <time of initial measurement> in FIG. 1. FIG. 4 is a diagram illustrating an example of weighting by the link quality calculation unit 121 in the operation diagram of FIG. 3. FIG. 5 is a diagram illustrating an example of measurement path calculation by the path calculation function unit 122 in the operation diagram of FIG. 3.

As illustrated in FIG. 3, the case where the delay measurement device 100 is connected to the delay measurement target network 10 and measures the delay amount and the jitter from the start point D to the end point E is taken as an example. However, since the delay measurement device 100 is connected to the end point B, in a case where the delay amount and the jitter at the end points D-E are measured, the delay measurement device 100 is affected by the delay or the like at the end points B-D.

Actual delay/packet loss rate of each link between the end points of the measurement target network 10 is as illustrated in FIG. 3. That is, the actual delay/packet loss rate between A and B is 10 μs/0%, the actual delay/packet loss rate between B and C is 10 μs/0%, the actual delay/packet loss rate between B and D is 100 μs/30%, the actual delay/packet loss rate between A and D is 10 μs/0%, and the actual delay/packet loss rate between D and E is 10 μs/0%. Note that the delay measurement device 100 does not grasp the actual delay/packet loss rate of each link between the end points as described above at <time of initial measurement>.

The link quality calculation unit 121 of the path calculation unit 120 calculates link quality calculation on the basis of data (topology, the delay amount of each link, the jitter, and the packet loss rate) measured in the past and stored in the NW state holding DB 112. This link quality calculation is weighting based on the measurement result.

However, at <time of initial measurement>, the past data, which is the measurement result, does not exist in the NW state holding DB 112 (see the broken line arrow in FIG. 3). Therefore, as illustrated in FIG. 4, the link quality calculation unit 121 generates a weighted topology 52 by setting the weights of all the links to be the same (1 in FIG. 4). That is, the link quality calculation unit 121 reflects the link quality in the topology as a weight. The topology data described above is collected from reading of an external file, a router, or the like.

The path calculation function unit 122 of the path calculation unit 120 performs path calculation in which the minimum sum of the weights is set as the shortest path on the basis of the weighted topology 52 in which the link quality is reflected in the topology as a weight.

At <time of initial measurement>, since the weighted topology 52 is generated with the weights of all the links being the same, when the measurement path calculation is performed with the minimum sum of the weights, the measurement paths (measurement end points D-E: path B-D-E) indicated by the signs d and e in FIG. 5 are calculated.

The path calculation function unit 122 sends the calculated measurement path information 53 (measurement end points D-E: path B-D-E) to the NW measurement unit 111 of the measurement unit 110.

The NW measurement unit 111 of the measurement unit 110 transmits a measurement packet to the end point B of the measurement target network 10 using the calculated measurement path information 53 (measurement end points D-E: path B-D-E) (see signs d and e in FIG. 3), and measures the delay of each link, the jitter, and the packet loss of the measurement target network 10.

<Time of Measurement>

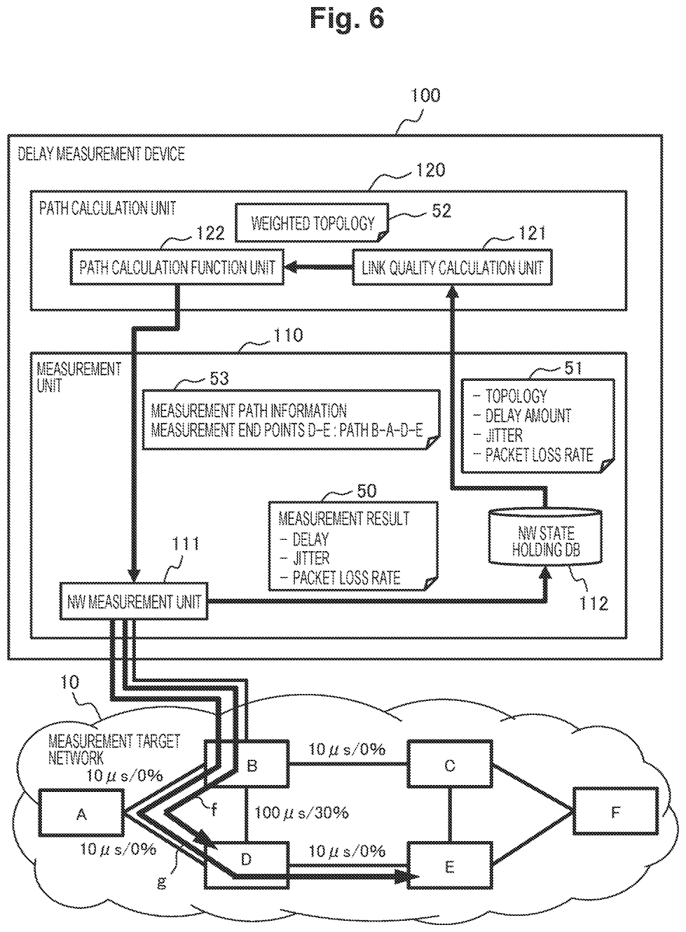

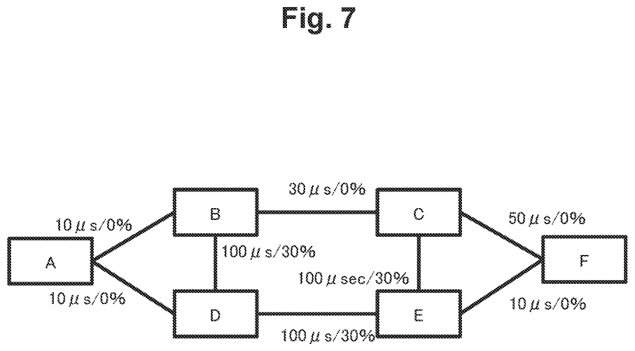

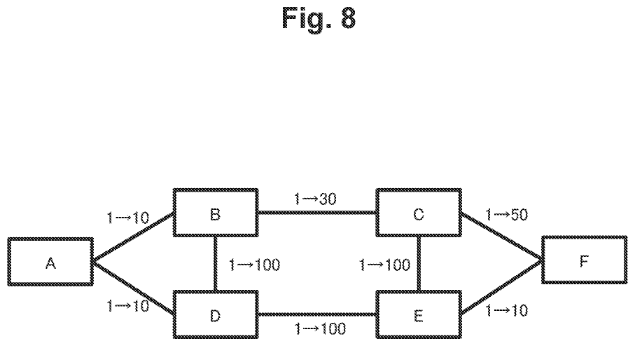

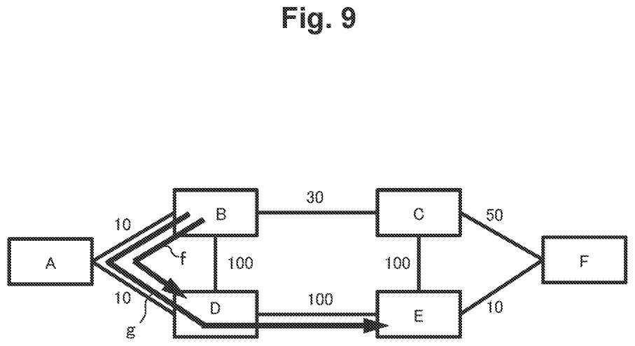

FIG. 6 is a diagram describing an operation of the delay measurement device 100 at <time of measurement> in FIG. 1. FIG. 7 is a diagram illustrating an example of the measurement result of each link stored in the NW state holding DB 112 in the operation diagram of FIG. 6. FIG. 8 is a diagram illustrating an example of weighting by the link quality calculation unit 121 in the operation diagram of FIG. 6. FIG. 9 is a diagram illustrating an example of measurement path calculation by the path calculation function unit 122 in the operation diagram of FIG. 6.

As illustrated in FIG. 6, the NW measurement unit 111 of the measurement unit 110 measures the delay amount of each link, the jitter, and the packet loss rate by the measurement at <time of initial measurement> described in FIGS. 3 to 5, and stores the measurement result 50 (see FIG. 6) in the NW state holding DB 112. Here, as illustrated in FIG. 7, the NW measurement unit 111 stores, as the measurement result 50 of each link of the measurement target network 10 in the NW state holding DB 112, the following:
actual delay/packet loss rate between A and B: 10 μs/0%,
actual delay/packet loss rate between B and C: 30 μs/0%,
actual delay/packet loss rate between B and D: 100 μs/30%,
actual delay/packet loss rate between A and D: 10 μs/0%,
actual delay/packet loss rate between D and E: 100 μs/30%,
actual delay/packet loss rate between C and E: 100 μs/30%,
actual delay/packet loss rate between C and F: 50 μs/0%, and
actual delay/packet loss rate between E and F: 10 μs/0%.

As illustrated in FIG. 6, the NW state holding DB 112 measures and collects past data 51 (NW state information including topology, delay amount of each link, jitter, and packet loss rate), which is a measurement result, and sends the past data 51 to the link quality calculation unit 121.

As illustrated in FIG. 6, the link quality calculation unit 121 updates the weighting of the links on the basis of the past data 51 (topology, delay amount of each link, jitter, and packet loss rate) and generates the weighted topology 52. Here, as illustrated in FIG. 8, the link quality calculation unit 121 updates the weights of “1” of all the links at <time of initial measurement> on the basis of the measurement result illustrated in FIG. 7 as described below.
Weight of link between A and B: 1=>10
Weight of link between B and C: 1=>30
Weight of link between B and D: 1=>100
Weight of link between A and D: 1=>10
Weight of link between D and E: 1=>100
Weight of link between C and E: 1=>100
Weight of link between C and F: 1=>50
Weight of link between E and F: 1=>10

The path calculation function unit 122 (see FIG. 1) of the path calculation unit 120 performs path calculation in which the minimum sum of the weights is set as the shortest path on the basis of the weighted topology 52 in which the link quality is reflected in the topology as a weight. Here, the shortest path having the minimum sum of the weights illustrated in FIG. 9 is calculated. That is, it is as described below.
Minimum sum of weights of link between A and B: 10
Minimum sum of weights of link between B and C: 30
Minimum sum of weights of link between B and D: 100
Minimum sum of weights of link between A and D: 10
Minimum sum of weights of link between D and E: 100
Minimum sum of weights of link between C and E: 100
Minimum sum of weights of link between C and F: 50
Minimum sum of weights of link between E and F: 10

Here, the calculation formula and the coefficient used to calculate the weights are determined according to the requirements of the network to be adopted. For example, a calculation formula used to calculate the weights is expressed by Formula (2) described below.

Weight calculation result=average delay×delay coefficient+average jitter×jitter coefficient+average packet loss×packet loss coefficient (2)

For the average delay, the average jitter, and the average packet loss described above, for example, an average value of values measured in the last 30 seconds can be used. An example of the coefficient is as described below.
Delay: 0
Jitter: 1
Packet loss: 10
Allowable hop count difference (described below): 2

The path calculation function unit 122 (see FIG. 6) determines the coefficient of each item in consideration of the measurement influence.

At <time of measurement>, as a result of calculating the path to the measurement start point with the minimum sum of the weights illustrated in FIG. 9, a measurement path (measurement end points B-A-D: path B-A-D-E) illustrated by the signs f and g in FIG. 9 is calculated.

The path calculation function unit 122 sends the calculated measurement path information 53 (measurement end points B-A-D: path B-A-D-E) to the NW measurement unit 111 of the measurement unit 110.

The NW measurement unit 111 of the measurement unit 110 transmits the measurement packet to the end point B of the measurement target network 10 using the calculated measurement path information 53 (measurement end points B-A-D: path B-A-D-E). Here, the minimum sums of the weights of the link between A and B and the link between A and D are both “10” (see FIG. 9), and even when the path passes through the end point A, the minimum sum of the weights of the link between A and D is smaller than “100”, and thus the measurement path passing through the end point A is adopted.

As described above, at <time of measurement>, unlike at <time of initial measurement> in FIG. 3, the measurement packet is transmitted through the measurement path (measurement end points B-A-D: path B-A-D-E) passing through the end point A, and the path calculation function unit 122 measures the delay amount of each link, the jitter, and the packet loss of the measurement target network 10.

The measurement result 50 (see FIG. 6) at <time of measurement> is stored in the NW state holding DB 112.

The above procedure is repeated for each measurement of each link, and the measurement data 51 stored in the NW state holding DB 112 is updated.

As described with reference to FIGS. 3 to 9, the delay measurement device 100 reflects the calculated link quality weight on the links of the topology and generates the weighted topology information. In the present embodiment, when the measurement path is calculated, a path having the minimum sum of weights is adopted as a path to the start point as one of indices. This enables measurement via a path with high quality.

### Application Examples

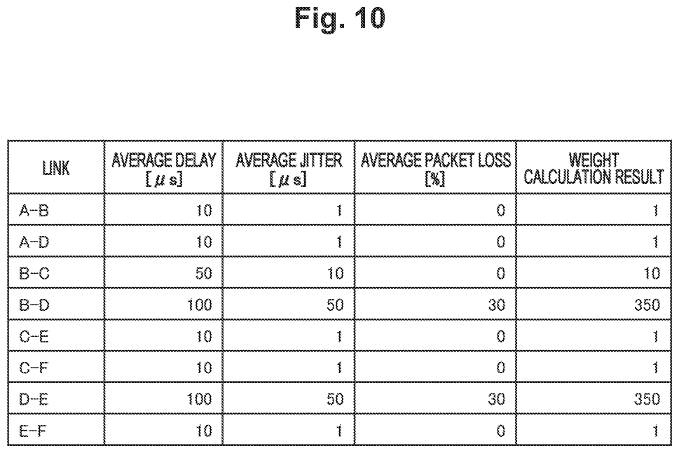

Application examples will be described with reference to FIGS. 10 to 12.

FIG. 10 is a diagram illustrating an example of weight calculation performed on the basis of a past measurement result. FIG. 10 stores the average delay [μs], the average jitter [μs], the average packet loss [%], and the weight calculation result for each link. As illustrated in FIG. 10, for example, when attention is paid to measurement target section D-E, the weight calculation result of the link between B and D is “350”, which is remarkably larger than “1”, which is the weight calculation results of the links between A and B and A and D connected to the measurement start point D. Therefore, it can be seen that the measurement path (measurement end points D-E: path B-D-E) indicated by the signs d and e in FIG. 5 may be bypassed, and the measurement path (measurement end points B-A-D: path B-A-D-E) indicated by the signs f and g in FIG. 9 may be adopted.

However, an allowable hop count difference is provided so as not to adopt an extreme bypass path.

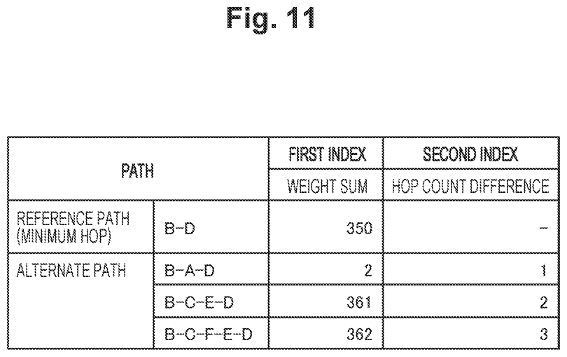

FIG. 11 is a diagram illustrating a path derivation example in which a first index and a second index are provided. FIG. 11 illustrates an example of deriving a path from the delay measurement device 100 to the measurement start point (from the end point B to the start point D or the start point E).

In FIG. 11, the weight of each link is calculated using a weight, which is calculated by setting the coefficient in which the avoidance of the packet loss influence is set to the first priority and the avoidance of the jitter influence is set to the second priority, as the first index.

In addition, in order to suppress the risk of the measurement influence due to bypassing of the path, the allowable hop count difference based on the minimum hop path is calculated as the second index.

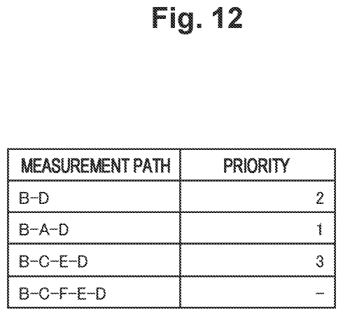

FIG. 12 is a diagram illustrating an example of determining a measurement path on the basis of the path derivation example of FIG. 11.

In FIG. 12, a path (B-A-D) in which the weight, which is the first index, is the minimum sum and that has a hop count difference, which is the second index, is adopted as the path to the measurement start point on the basis of the calculation result of FIG. 11.

[Modification]

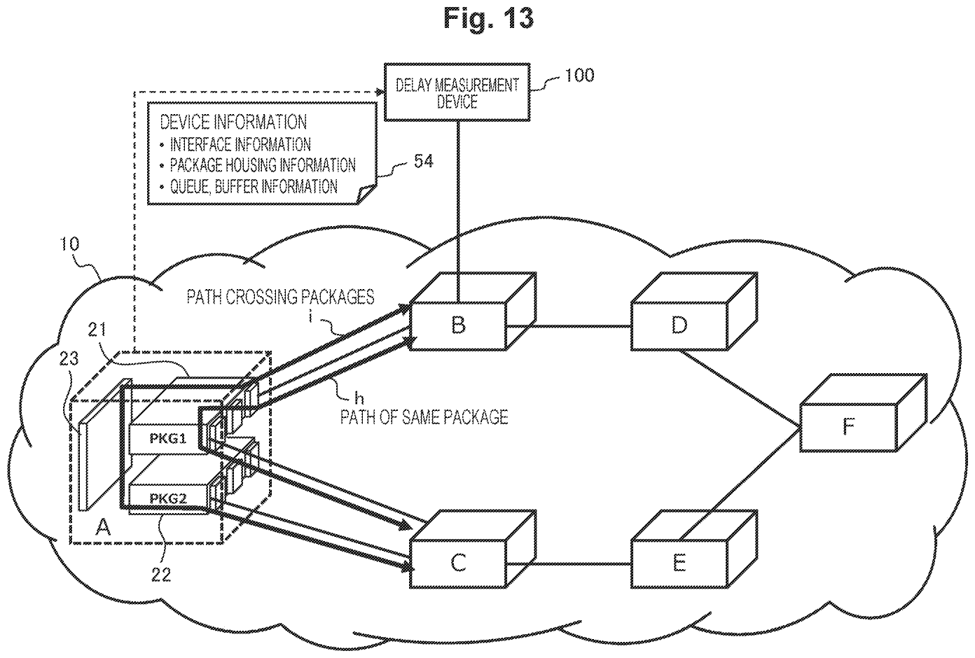

FIG. 13 is a diagram illustrating a configuration example of the delay measurement device 100 according to a modification of the embodiment. FIG. 13 illustrates an example in which a large-scale device is used as the measurement target network. The same components as those in FIG. 1 are denoted by the same reference signs.

As illustrated in FIG. 13, the delay measurement device 100 is connected to the measurement target network 10. In the measurement target network 10, the end point A in FIG. 1 includes a device A.

The device A includes housing packages 21 and 22 (PKG1 and PKG2) having a router or gateway function and a housing interface 23 that houses and connects the housing packages 21 and 22 (PKG1 and PKG2) in a casing indicated by the broken line in FIG. 13.

Even in the same measurement path, the device A is assumed to affect the communication quality depending on the usage status of the housing interface 23 and the housing packages 21 and 22 (PKG1 and PKG2). A path indicated by the sign h in FIG. 13 is a path of the same package (only PKG1), and a path indicated by the sign i in FIG. 13 is a path crossing packages (PKG1, PKG2, and housing interface 23).

In the modification, the measurement path is optimized in consideration of the housing packages 21 and 22 (PKG1 and PKG2) and the housing interface 23 so that the measurement influence due to the delay, jitter, and the like in the device A can be minimized. Therefore, the delay measurement device 100 acquires device information 54 (interface information, package housing information, queue, and buffer information of the device A) from the device A to optimize the measurement path. For example, the end point of the device A is divided into an end point A1 (not illustrated) in the case of passing through the housing package 21 (PKG1) and the housing interface 23, and an end point A2 (not illustrated) in the case of passing through the housing package 22 (PKG2) and the housing interface 23, and a path calculated in consideration of the path quality to the measurement target section is calculated for each end point.

In addition, as another modification, since jitter and packet loss occur due to a processing influence inside the device, it is assumed that a measurement result is affected by a packet transmission/reception timing. Therefore, a mode is also possible in which the delay measurement device 100 feeds back the time when the measurement packet is transmitted, the time when the measurement packet is received, and the measurement result to a measurement path optimization device, which is not illustrated, and the measurement path optimization device performs the measurement path optimization.

[Hardware Configuration]

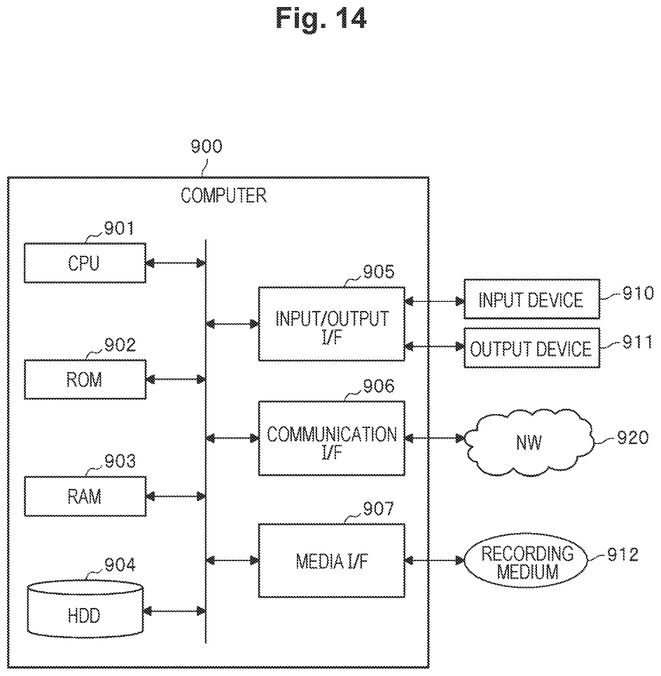

The delay measurement method according to the present embodiment is realized by a computer 900 that is a physical device having a configuration as illustrated, for example, in FIG. 14.

FIG. 14 is a hardware configuration diagram illustrating an example of a computer that realizes processing of the delay measurement method according to the embodiment of the present invention.

The computer 900 includes a CPU 901, ROM 902, RAM 903, an HDD 904, a communication interface (I/F) 906, an input/output interface (I/F) 905, and a media interface (I/F) 907.

The CPU 901 operates on the basis of a program stored in the ROM 902 or the HDD 904, and controls each unit of the delay measurement device 100 illustrated in FIG. 1. The ROM 902 stores a booting program to be executed by the CPU 901 when the computer 900 is activated, a program depending on the hardware of the computer 900, or the like.

The CPU 901 controls an input device 910 such as a mouse or a keyboard, and an output device 911 such as a display via the input/output I/F 905. The CPU 901 acquires data from the input device 910 and outputs created data to the output device 911 via the input/output I/F 905. Note that a graphics processing unit (GPU) or the like may be used as a processor in conjunction with the CPU 901.

The HDD 904 stores a program to be executed by the CPU 901, data to be used by the program, and the like. The communication I/F 906 receives data from another device via a communication network (for example, a network (NW) 920), outputs the data to the CPU 901, and transmits data generated by the CPU 901 to another device via the communication network.

The media I/F 907 reads a program or data stored in a recording medium 912, and outputs the program or data to the CPU 901 via the RAM 903. The CPU 901 loads a program related to target processing from the recording medium 912 on the RAM 903 via the media I/F 907 and executes the loaded program. The recording medium 912 is an optical recording medium such as a digital versatile disc (DVD) or a phase change rewritable disk (PD), a magneto-optical recording medium such as a magneto-optical disk (MO), a magnetic recording medium, a conductor memory tape medium, a semiconductor memory, or the like.

For example, in a case where the computer 900 functions as the delay measurement device 100 configured as a device according to the present embodiment, the CPU 901 of the computer 900 implements the function of the delay measurement device 100 by executing a program loaded on the RAM 903. The HDD 904 stores the data in the RAM 903. The CPU 901 reads the program related to the target processing from the recording medium 912, and executes the program. Additionally, the CPU 901 may read a program related to the target processing from another device via a communication network (the NW 920).

[Effects]

Hereinafter, effects of the delay measurement device and the like according to the present invention will be described.

The delay measurement device 100 according to the present invention is a delay measurement device that measures a delay of a network (measurement target network 10 in FIG. 1) configured by connecting a plurality of end points to each other, and includes the NW measurement unit 111 (see FIG. 1) that measures a topology, a delay amount of each link, jitter, and a packet loss rate, and causes the NW state holding unit to hold them as NW state information, the link quality calculation unit 121 (see FIG. 1) that calculates the link quality between the end points as a weight on the basis of the NW state information including the topology, the delay amount of each link, the jitter, and the packet loss rate, and the path calculation function unit 122 (see FIG. 1) that calculates a measurement path on the basis of a weighted topology in which the weight of the link quality calculated by the link quality calculation unit 121 is reflected in the topology, in which the NW measurement unit 111 transmits a measurement packet to the start point end point and measures the delay amount of the measurement target section of the NW on the basis of the measurement path calculated by the path calculation function unit 122.

As described above, in the present invention, the NW state information (measurement result including delay amount, jitter, and packet loss rate) is measured, and the past measurement result is fed back to the measurement path calculation, so that the influence of the quality deterioration of the network can be minimized. For example, even in a case where the jitter increases in the path from the delay measurement device 100 to the measurement start point, it is possible to prevent the delay amount and the jitter in the measurement target section from being calculated to be larger than actual ones, and to measure accurate information. In addition, even in a case where packet loss due to quality deterioration occurs in the path to the measurement start point, it is possible to prevent that the measurement fails due to the loss of the measurement packet or a loss rate higher than the actual packet loss rate is recorded.

In addition, the delay measurement device 100 is characterized in that the path calculation function unit 122 calculates a path in which the weight of the link quality becomes the minimum sum as a measurement path.

This enables measurement via a path with high quality. In addition, by changing the weighting calculation method, it is possible to perform network monitoring according to the network design and the policy of the operator.

In addition, the delay measurement device 100 is characterized in that the link quality calculation unit 121 calculates the weight of each link using a weight, which is calculated by setting the coefficient in which the avoidance of the packet loss influence is set to the first priority and the avoidance of the jitter influence is set to the second priority, as the first index.

Thus, it is possible to minimize the influence due to the quality deterioration of the network while avoiding the packet loss influence.

In addition, the delay measurement device 100 is characterized in that the link quality calculation unit 121 calculates the weight of each link using the allowable hop count difference based on the minimum hop path as a second index.

In this way, by selecting a path the hop count difference from the reference path is equal to or less than a certain value, it is possible to perform measurement via a path with high quality while limiting a bypass path.

[Others]

Of the individual processes described in the foregoing embodiment, all or some of the processes described as being automatically performed can be manually performed. Alternatively, all or some of the processes described as being manually performed can be automatically performed by a known method. In addition, information including the processing procedures, the control procedures, specific names, various kinds of data, and parameters described above in the document or drawings can be arbitrarily modified unless otherwise particularly specified.

In addition, each component of each device that has been illustrated is functionally conceptual, and is not necessarily physically configured as illustrated. That is, a specific form of distribution and integration of individual devices is not limited to the illustrated form, and all or a part of the configuration can be functionally or physically distributed and integrated in any unit according to various loads, usage conditions, and the like.

In addition, some or all of the above-described configurations, functions, processing units, processing means, and the like may be realized by hardware, for example, by designing with an integrated circuit. In addition, each of the above-described configurations, functions, and the like may be realized by software for interpreting and executing a program for the processor to realize each function. Information such as a program, a table, and a file for realizing each function can be held in a recording device such as a memory, a hard disk, and a solid state drive (SSD), or a recording medium such as an integrated circuit (IC) card, a secure digital (SD) card, and an optical disk. In addition, in the present specification, the processing steps describing the time-series processing include not only processing performed in time series according to the described order, but also processing executed in parallel or individually (for example, parallel processing or processing by an object) and not necessarily performed in time series.

### REFERENCE SIGNS LIST

10 Measurement target network (network)
52 Weighted topology
100 Delay measurement device
110 Measurement unit
111 NW measurement unit
112 NW state holding DB (NW state holding unit)
120 Path calculation unit
121 Link quality calculation unit
122 Path calculation function unit
A to F End point

This listing of claims replaces all prior versions and listings of claims in the application:

1. A delay measurement device that measures a delay of a network (NW) configured by connecting a plurality of end points to each other, the delay measurement device comprising:
a NW measurement unit, implemented using one or more processors, configured to measure a topology, a delay amount of each link, jitter, and a packet loss rate, and cause a NW state holding unit implemented using one or more processors, to hold the topology, the delay amount of each link, the jitter, and the packet loss rate as NW state information;
a link quality calculation unit implemented using one or more processors, configured to calculate a link quality between the end points as a weight on a basis of the NW state information including the topology, the delay amount of each link, the jitter, and the packet loss rate; and
a path calculation function unit implemented using one or more processors, configured to calculate a measurement path on a basis of a weighted topology in which the weight of the link quality calculated by the link quality calculation unit is reflected in the topology,
wherein the NW measurement unit is configured to transmit a measurement packet to a start point end point and measure a delay amount of a measurement target section of the NW on a basis of the measurement path calculated by the path calculation function unit.

2. The delay measurement device according to claim 1, wherein the path calculation function unit is configured to calculate a path in which the weight of the link quality becomes a minimum sum as the measurement path.

3. The delay measurement device according to claim 1, wherein the link quality calculation unit is configured to calculate the weight of each link using a weight calculated by setting a coefficient in which avoidance of packet loss influence is set to a first priority and avoidance of jitter influence is set to a second priority as a first index.

4. The delay measurement device according to claim 3, wherein the link quality calculation unit is configured to calculate the weight of each link using an allowable hop count difference based on a minimum hop path as a second index.

5. A delay measurement method of a delay measurement device configured to measure a delay of a network (NW) configured by connecting a plurality of end points to each other, wherein the delay measurement device is configured to perform operations comprising:
measuring a topology, a delay amount of each link, jitter, and a packet loss rate, and holding the topology, the delay amount of each link, the jitter, and the packet loss rate as NW state information;
calculating a link quality between the end points as a weight on a basis of the NW state information including the topology, the delay amount of each link, the jitter, and the packet loss rate;
calculating a measurement path on a basis of a weighted topology in which the weight of the calculated link quality is reflected in the topology; and
transmitting a measurement packet to a start point end point and measuring a delay amount of a measurement target section of the NW on a basis of the calculated measurement path.

6. A non-transitory computer readable medium storing a program, wherein executing the program causes a computer to execute a delay measurement method comprising:
measuring a topology, a delay amount of each link, jitter, and a packet loss rate, and holding the topology, the delay amount of each link, the jitter, and the packet loss rate as NW state information;
calculating a link quality between the end points as a weight on a basis of the NW state information including the topology, the delay amount of each link, the jitter, and the packet loss rate;
calculating a measurement path on a basis of a weighted topology in which the weight of the calculated link quality is reflected in the topology; and
transmitting a measurement packet to a start point end point and measuring a delay amount of a measurement target section of the NW on a basis of the calculated measurement path.
